(19) United States
(12) Patent Application Publication
(10) Pub. No.: US 2016/0019354 A1
(43) Pub. Date: Jan. 21, 2016

(54) METHODS AND SYSTEMS FOR MANAGING HEALTH CARE INFORMATION AND DELIVERY OF HEALTH CARE SERVICES

(71) Applicant: EMDEON, INC., NASHVILLE, TN (US)

(72) Inventors: DAVID S. GRANT, MISSION VIEJO, CA (US); TORSTEN KABLITZ, AUBURN, WA (US)

(73) Assignee: EMDEON, INC., NASHVILLE, TN (US)

(21) Appl. No.: 14/800,879

(22) Filed: Jul. 16, 2015

Related U.S. Application Data
(60) Provisional application No. 62/025,633, filed on Jul. 17, 2014.

(51) Int. Cl. G06F 19/00

(52) U.S. Cl. CPC G06F 19/327

(57) ABSTRACT

Embodiments of the invention provide systems and methods directed to managing health care information and delivery of health care services by maintaining a set of workflows for processing of health care information or managing the delivery of the health care services according to different modes of operation, e.g., a base operation mode and a revenue generation mode. A set of reference data and a set of rules applicable to the set of health care information or the delivery of the one or more health care service can also be maintained. When health care transaction information is received from one or more parties, e.g., a patient, a health care provider, a pharmacy, or a payer, one or more of the workflows can be executed to process the received health care transaction information based on the set of reference data and the set of rules.

### CROSS-REFERENCE TO RELATED APPLICATIONS

The present application claims benefit under 35 USC 119(e) of U.S. Provisional Application No. 62/025,633, filed on Jul. 17, 2014 by Grant and entitled “Methods and Systems for managing Health Care Information and Delivery of Health Care Services,” of which the entire disclosure is incorporated herein by reference for all purposes.

### BACKGROUND OF THE INVENTION

Embodiments of the present invention relate generally to methods and systems for managing health care information and delivery of health care services and more particularly to systems and methods directed to managing health care information and delivery of health care services by maintaining a set of workflows for processing of health care information or managing the delivery of the health care services according to different modes of operation.

Electronic Health Records (EHRs) have been marketed as tools to reduce errors, rework and time savers for providers. However, these tools have traditionally met with resistance from actual providers because many of the potential benefits have not been realized except in some larger staff model environments where the added cost can be absorbed or underwritten. Current systems are dependent on reference data which are ongoing maintenance and costs for these systems and do not include real time payer rules that dictate benefit design and service contracts for a given patient in the Clinician's workflow. Although general eligibility and coverage information are available in most practice management systems software system however; there are no simple, workflow-optimized solutions for the clinicians in the service decision process or execution. Without this workflow guidance, many of current systems simply become data capture solutions that support electronic automation for script writing, lab orders, referrals and other automated tasks. Additionally, increased data entry requirements negatively impact productivity. For example, a two (2) minute increase for electronic data capture represents 1 hour of lost productivity for the average practicing provider. Therefore, many if not most providers delegate the data entry tasks to their staff so they can focus their time on patient interaction and diagnosis, thereby missing the opportunity for optimized service delivery. Hence, there is a need for improved methods and systems for methods and systems for managing health care information and delivery of health care services.

### BRIEF SUMMARY OF THE INVENTION

Embodiments of the invention provide systems and methods for managing health care information and delivery of health care services. More specifically, embodiments of the invention provide systems and methods directed to managing health care information and delivery of health care services by maintaining a set of workflows for processing of health care information or managing the delivery of the health care services according to different modes of operation, e.g., a base operation mode and a revenue generation mode. A set of reference data and a set of rules applicable to the set of health care information or the delivery of the one or more health care service can also be maintained. When health care transaction information is received from one or more parties, e.g., a patient, a health care provider, a pharmacy, or a payer, one or more of the workflows can be executed to process the received health care transaction information based on the set of reference data and the set of rules. For example in base mode, processing the transaction can comprise aggregating drug reference data, payer formulary data, drug history data, or benefit eligibility data from different sources and/or routing a prescription between parties. In revenue generation mode, the functions can include: enrollment functions; tracking, reporting, and managing the routing and fulfillment of the prescription; switching one or more payer formularies; switching a brand drug for a generic drug; switching therapies; preferred dispensing functions; optimizing a dispensing quantity; automating a mail order enrollment; script monetization or couponing functions; etc.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating an exemplary a hub for managing health care information and delivery of health care services according to one embodiment of the present invention.

FIG. 4 is a block diagram illustrating an overview of exemplary components and processes in a system for managing health care information and delivery of health care services according to one embodiment of the present invention.

FIG. 5 is a flowchart illustrating an overview of a process for managing health care information and delivery of health care services according to one embodiment of the present invention.

FIG. 6 is a flowchart illustrating an integration process according to one embodiment of the present invention.

FIG. 7 is a flowchart illustrating a process for formulary switching according to one embodiment of the present invention.

FIG. 8 is a flowchart illustrating a process for dispensing switching and script monetization according to one embodiment of the present invention.

FIG. 9 is a flowchart illustrating a process for payer processing according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods directed to managing health care information and delivery of health care services by maintaining a set of workflows for processing of health care information or managing the delivery of the health care services according to different modes of operation, e.g., a base operation mode and a revenue generation mode. A set of reference data and a set of rules applicable to the set of health care information or the delivery of the one or more health care service can also be maintained. When health care transaction information is received from one or more parties, e.g., a patient, a health care provider, a pharmacy, or a payer, one or more of the workflows can be executed to process the received health care transaction information based on the set of reference data and the set of rules. For example in base mode, processing the transaction can comprise aggregating drug reference data, payer formulary data, drug history data, or benefit eligibility data from different sources and/or routing a prescription between parties. In revenue generation mode, the functions can include: enrollment functions; tracking, reporting, and managing the routing and fulfillment of the prescription; switching one or more payer formularies; switching a brand drug for a generic drug; switching therapies; preferred dispensing functions; optimizing a dispensing quantity; automating a mail order enrollment; script monetization or couponing functions; etc. Various additional details of embodiments of the present invention will be described below with reference to the figures.

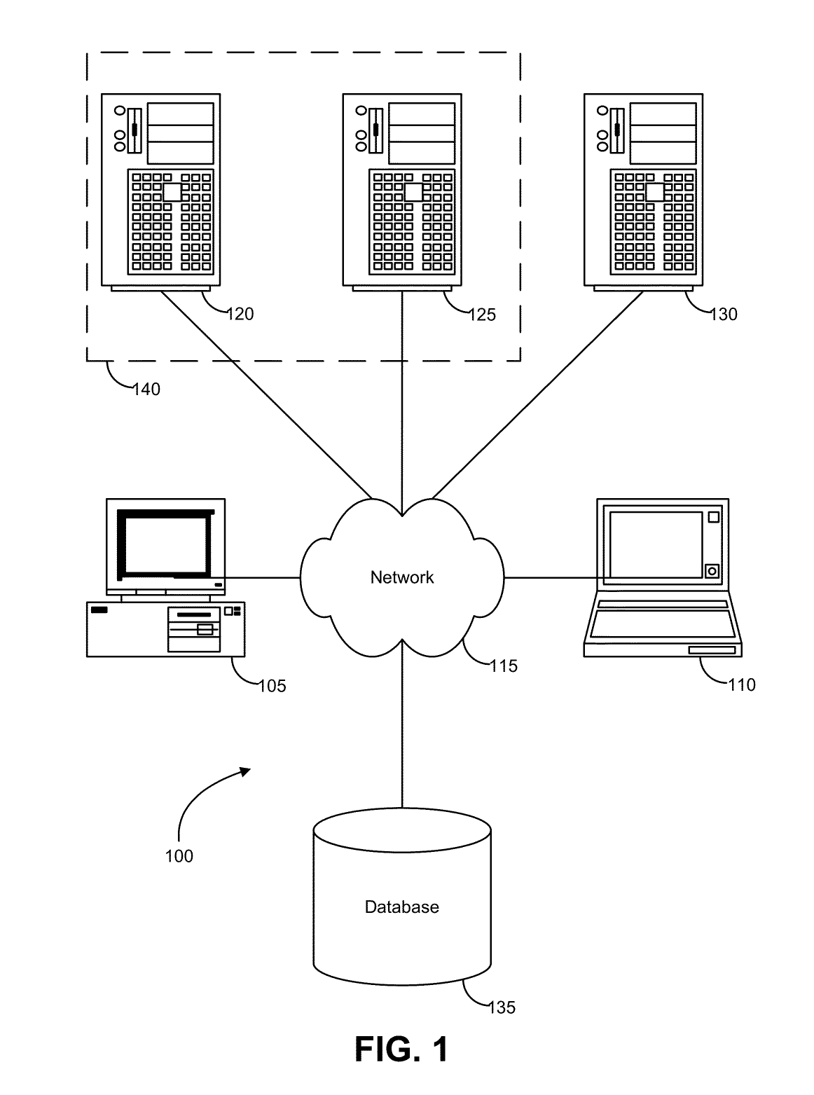

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

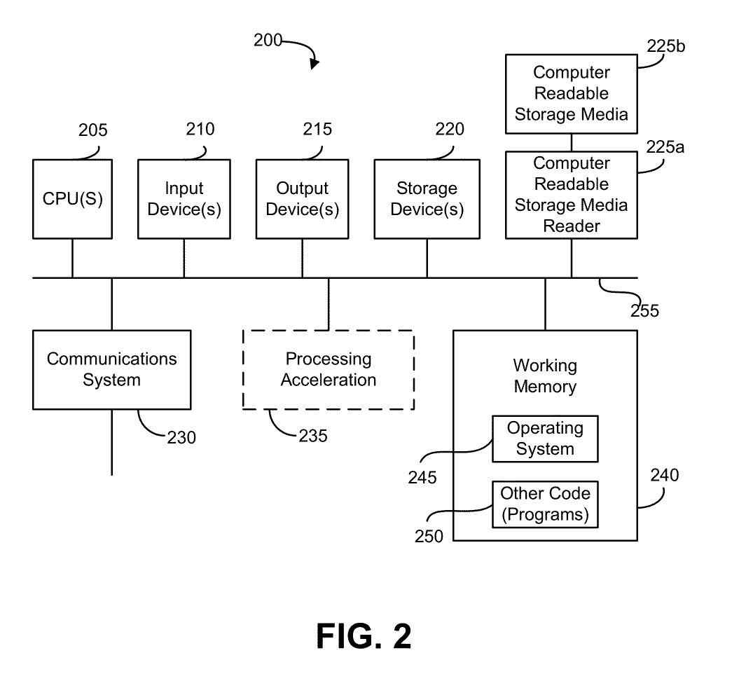

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

As noted above, embodiments of the invention provide systems and methods directed to managing health care information and delivery of health care services by maintaining a set of workflows for processing of health care information or managing the delivery of the health care services according to different modes of operation. More specifically, embodiments of the present invention can include a system, that provides a hub between different parties including but not limited to payers (e.g., insurance companies), employers, tech vendors, prescribers, pharmacists, and/or patients. Different functions of the system can be directed to the interests of these different parties. For example, the system can provide to the payer real-time control over formulary design while providing to employers functions to help lower costs and improve outcomes. In other cases, the system can provide to tech vendors streamlined connectivity to functions for accurately controlling formularies and/or for providing prescriber incentives to increase adoption. Additionally or alternatively, the system can provide to prescribers functions for generating real-time, formulary compliant prescriptions to simplify workflow. To pharmacists, the system can provide functions for filling formulary compliant prescriptions to eliminate doctor callbacks and can provide a window into prescription status.

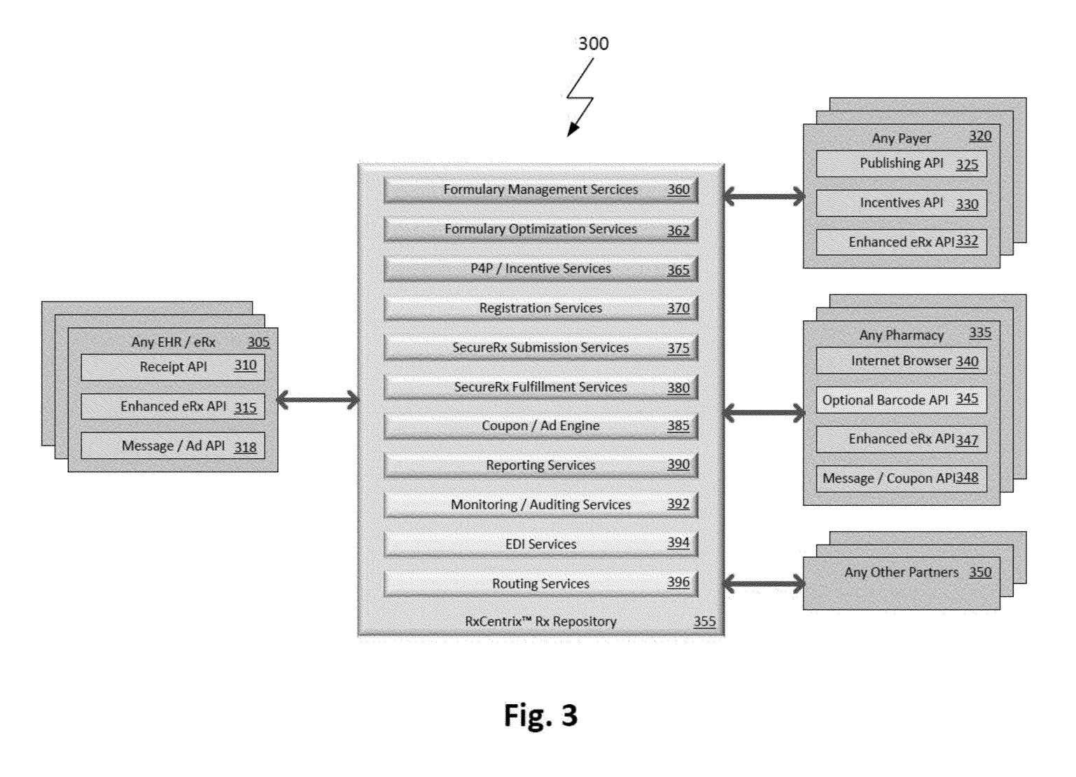

FIG. 3 is a block diagram illustrating an exemplary a hub for managing health care information and delivery of health care services according to one embodiment of the present invention. This example illustrates a number of systems 300 which may be implemented on one or more servers or other computer systems as described above. These systems 300 can be connected with and communicate over any one or more communications networks such as the Internet or any other one or more local area or wide area networks as described above.

More specifically, one or more systems 305 can be directed to prescribers, providers, or other generators of electronic health records and/or electronic prescriptions. This system 305 can provide, for example a receipt Application Program Interface (API) 310 or other interface, an enhanced e-prescription API 315, and/or a message, coupon, ad API 318. Additionally or alternatively, one or more systems 320 can be directed to payers and can provide publishing APIs 325, incentive APIs 330, and/or enhanced e-prescription API 332 or other interfaces. One or more systems 335 may also be directed to pharmacies and can provide a browser 340, barcodes APIs 345, enhanced e-prescription API 347, and/or a message, coupon, ad API 348 or other interfaces. Other partner systems 350 supporting similar or other APIs or other interfaces are contemplated.

Each of these systems 300 can communicate and interact with, through the various APIs, a number of services of a pharmacy-centric repository system or hub system 355. The services provided by this system 355 can include but are not limited to formulary management services 360, formulary optimization 362, P4P/incentive services 365, registration services 370, prescription submission services 375, prescription fulfillment services 380, a coupon or ad engine 385, reporting services 390, monitoring/audit services 392, healthcare EDI services 394, and message routing services 396. Together or individually, these service can be directed to managing health care information and delivery of health care services by maintaining and executing a set of workflows for processing of health care information or managing the delivery of the health care services according to different modes of operation, e.g., a base operation mode and a revenue generation mode. A set of reference data and a set of rules applicable to the set of health care information or the delivery of the one or more health care service can also be maintained. When health care transaction information is received from one or more parties, e.g., a patient, a health care provider, a pharmacy, or a payer, one or more of the workflows can be executed to process the received health care transaction information based on the set of reference data and the set of rules. For example in base mode, processing the transaction can comprise aggregating drug reference data, payer formulary data, drug history data, or benefit eligibility data from different sources and/or routing a prescription between parties. In revenue generation mode, the functions can include: enrollment functions; tracking, reporting, and managing the routing and fulfillment of the prescription; switching one or more payer formularies; switching a brand drug for a generic drug; switching therapies; preferred dispensing functions; electronic prior authorization functions, targeted patient messaging functions, optimizing a dispensing quantity; automating a mail order enrollment; script monetization or couponing functions; etc. Additional details of these services and examples of each are described further below.

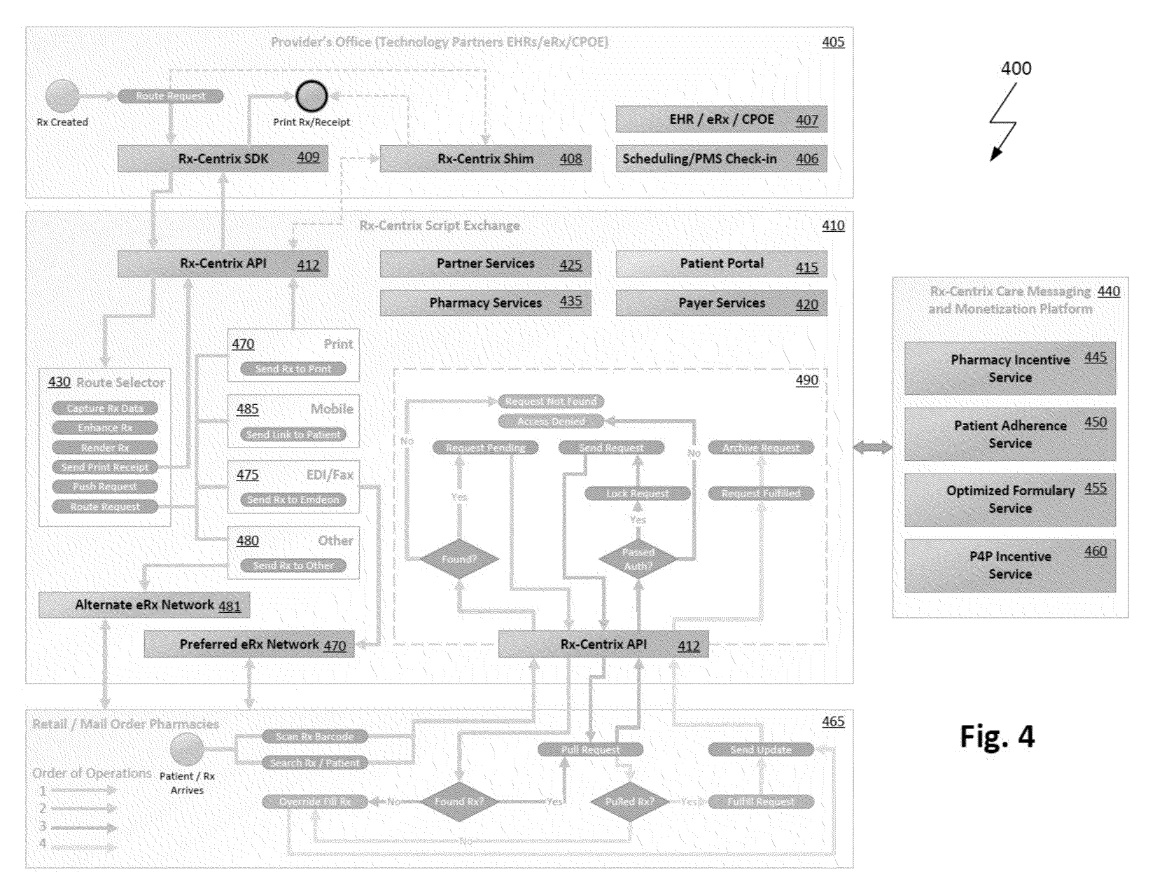

FIG. 4 is a block diagram illustrating an overview of exemplary components and processes in a system for managing health care information and delivery of health care services according to one embodiment of the present invention. As illustrated here, the system 400 can include one or more computer systems 405 of a doctor's or other provider's office. This system 405 can execute software providing any number of services including but not limited to patient scheduling and check-in 406, electronic health record and/or electronic prescription generation and maintenance 407, electronic prescription communication services 408 and 409, etc.

A script exchange system 410 such as the hub system 355 introduced above can communicate with the provider's system 405 through a script exchange API 412 and exchange information related to the electronic health records and/or electronic prescriptions. Also as introduced above, this system 410 can provide a number of services and/or functions including but not limited to a patient portal 415, payer services 420, partner services 425, a route selector 430, pharmacy services 435, etc.

A messaging and monetization system 440 may also be includes as part of or separate from the script exchange system 410. The messaging and monetization system 440 can provide, together with or in addition to the services provided by the script exchange system 410, one or more other services. These services can include but are not limited to a pharmacy incentive service 445, a patient adherence service 450, an optimized formulary service 455, an incentive service 460, etc.

One or more retail or mail order pharmacy systems 465 may be in communication with the script exchange system 410, also through the script exchange API 412, and can exchange information related to electronic prescriptions and/or electronic health records. For example, the pharmacy system 465 together with the script exchange system 410 and through the services provided by the script exchange system 410 and/or messaging and monetization system 440, can provide for capturing data related to an electronic prescription received through print 470, mobile 485, or EDI/fax 475 channels and/or the processing thereof, routing the electronic prescription to an appropriate pharmacy over a preferred pharmacy network 470, routing electronic prescriptions received through other channels 480 to an appropriate pharmacy over an alternate pharmacy network 481, adding incentives to the electronic prescription, centrally storing the electronic prescription (push), print receipts, validating and confirming the prescription 490, searching for prescriptions, etc. Additional details of these services and examples of each are described further below.

As noted, different functions of the system can be directed to the interests of different parties, i.e., pharmacies, prescribers or other provides, payers, patients, and/or other partners. For example, the system can provide to the payer real-time control over formulary design while providing to employers functions to help lower costs and improve outcomes thru formulary optimization. In other cases, the system can provide to tech vendors streamlined connectivity to functions for accurately controlling formularies and/or for providing prescriber incentives to increase adoption. Additionally or alternatively, the system can provide to prescribers functions for generating real-time, formulary compliant prescriptions to simplify workflow. To pharmacists, the system can provide functions for filling formulary compliant prescriptions to eliminate doctor callbacks and can provide a window into prescription status. To the patient, the system can provide a more personally directed workflow where the system 410 can hold the electronic prescription and then pharmacy chosen by the patient pulls the prescript from the system in real time at point of fulfillment. The patient could also forward the electronic prescription to a selected pharmacy for fulfillment before arriving to pick up their filled prescription. Also, the system 410 provides services to allow interested parties, such as the pharmacist and/or prescriber, to request additional information/workflow actions for an electronic prescription. These might include such workflows as attaching lab results and/or providing for electronic prior authorization of the electronic prescription.

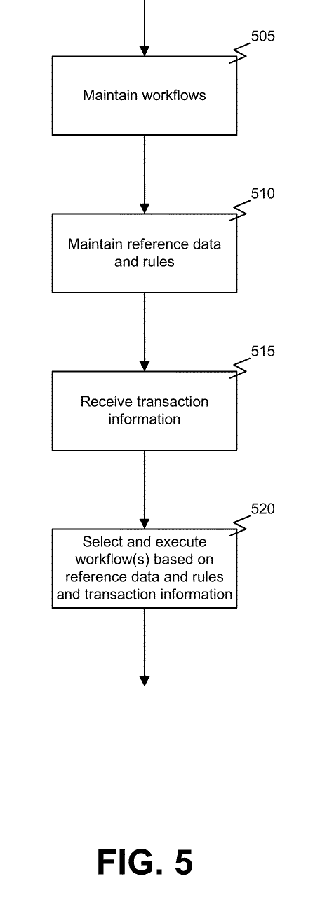

FIG. 5 is a flowchart illustrating an overview of a process for managing health care information and delivery of health care services according to one embodiment of the present invention. As illustrated here, the process can begin with maintaining 505 a set of workflows for processing of health care information or managing the delivery of the health care services according to different modes of operation, e.g., a base operation mode and a revenue generation mode. A set of reference data and a set of rules applicable to the set of health care information or the delivery of the one or more health care service can also be maintained 510. When health care transaction information is received 515 from one or more parties, e.g., a patient, a health care provider, a pharmacy, or a payer, one or more of the workflows can be selected and executed 520 to process the received health care transaction information based on the set of reference data and the set of rules. For example in base mode, processing the transaction can comprise aggregating drug reference data, payer formulary data, drug history data, or benefit eligibility data from different sources and/or routing a prescription between parties. In revenue generation mode, the functions can include: enrollment functions; tracking, reporting, and managing the routing and fulfillment of the prescription; switching one or more payer formularies; switching a brand drug for a generic drug; switching therapies; preferred dispensing functions; optimizing a dispensing quantity; automating a mail order enrollment; script monetization or couponing functions; etc. To illustrate how embodiments of the present invention address these shortcomings of current systems, a number of use cases will be described.

### Use Case: Integration and Maintenance Drug Reference and Formulary Data

In this use case, the “Actor” can be considered to be drug company, electronic prescription provider, electronic health record provider, or other entity, service, or system that can provide and maintain reference data for all drugs that may be legally prescribed and an automated means to prescribe a drug, or a set of drugs electronically. Both state and federal entities now require that they systems become certified to insure basic features for safe prescribing are enabled. For example, these automated electronic prescribing solutions must represent the appropriate dispensing options such as dose form, strength and delivery for any selected drug agent. These certification programs also include requirements on how the electronic script must be handled, transmitted and recorded. Actor prescribing solutions can also integrate and maintain formulary reference data that in most cases indicate to an electronic prescriber if a particular drug being prescribed is covered by the patients drug coverage plan and if generics or alternatives might be available. Actors systems often also include a means for electronically transmitting an electronic prescription to a retail or mail order pharmacy.

According to one embodiment, an Actor can use the e-prescription API provided by the system and as described above for integrated and automatically updated drug reference, accurate payer formulary, and electronic routing. The e-prescription API can couple together a pharmacy echo systems that enable predictive analytics, closed-loop prescribing and fill data and enabled enhanced messaging and workflow automation features not available today.

In the base operation mode, the e-prescription API can provide integrated features such as accurate and automatically synchronized drug reference and payer formulary data. This includes DUR and drug-drug interaction checking features. Additionally the e-prescription API can aggregate electronic routing and connectivity to retail and mail order pharmacies, and include localized Print, Fax and Store-Forward options for a highly available solution. In base operation mode the e-prescription API can also provide drug history, benefit eligibility from desperate sources to help reduce errors and enhance renewal workflows.

Base operation mode can enable Actors to utilize the same feature calls they currently use to display and record prescribing data to minimize integration impact, and can aggregate data sources into an automated service which will reduce or eliminate reference data and related maintenance expenses.

The e-prescription API can work stand-alone or in concert with the e-prescription network shim to enable a comprehensive prescribing systems alternative with the added feature for localized synchronization and high availability. Within the base operation mode, Actors can have the option to select Distributed Synchronization or Online Service modes.

With a distributed synchronization mode enabled, the e-prescription API can leverage internal high-speed networks to optimize performance and allow for intermittent internet outages without system failure. With an online service mode enabled the API can attempt to always use online web service calls first. However, because providers have valued performance as a predominate feature online service mode can monitor overall performance and provide alerts and information to the Actors, and if desired can automatically switch between these two modes based on performance thresholds.

Base Operation Mode can also include specific carve-out filtering to support any special or customized requirements on a patient specific basis that may require specialize routing.

Revenue generation mode can include the features of the base operation mode and can further provide payer incentive features that are generally Pay-4-Performance (P4P) drivers. In this mode, the system can enable revenue sharing features such as preferred formulary substitution, generic switch, step therapy alternatives, optimized dispensing, script monetization, predictive messaging, care management regimentation, and other similar features that are typically designed to drive the highest healthcare outcome and at the lowest costs. In revenue generation mode, at no times will the API prevent or impede a provider's ability, decision or choice to select a particular drug. This model simply aligns benefit design and payer incentive within the provider's normal workflow thereby providing value to both stakeholders in the prescribing event.

According to one embodiment, the Actor may be required to enroll to receive and enable the API. Each API can use Actor login credentials before it is activated as part of the system. The e-prescription API can enable Actors to enroll in the system seamlessly and authenticate with each route rather than certify once a year. This is because the system can be built on a web service pull architecture that maintains continuity thought the chain of custody and delivery of an atomic script transaction.

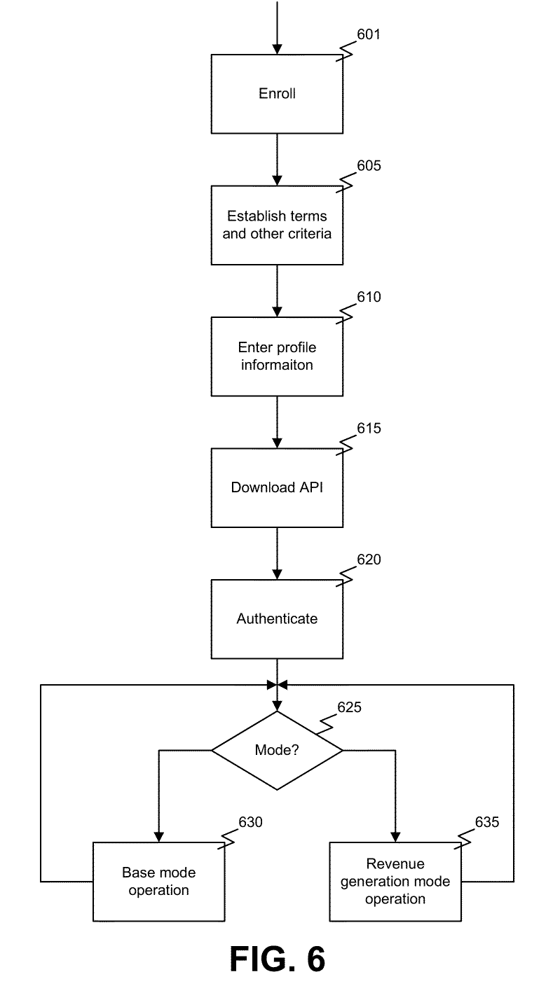

FIG. 6 is a flowchart illustrating an integration process according to one embodiment of the present invention. Actors can first enroll 601 in the systems where service providers participate. Terms of Service, Legal Contracts and Authentication Criteria can be established 605 during enrollment so there is not barrier to utilization or participation for any valid participate. The Actor is required to enter 610 profile information during registration such as company name, tax id for payment and billing, authorization and administration contact info for documentation authority. The rest is automated via the API and activation.

Once the enrollment process is completed the API can be accessed 615 along with service contracts and integration manuals. Access to the API is restricted at the source thru two factor authentication, firewalls, IP Whitelisting, and/or other security technologies.

According to one embodiment, two factor authentication 620 can be used to get started and NCPDP Script Standard transactions can be automatically authorized or rejected as part of the overall system. This allows Actors to lever the API within their own systems for registration and routing. For example, authorized prescribers in their system are automatically enrolled and enabled as part of this system which eliminated duplicity of setup and errors related to batch synchronization.

If their system does not include the base essential to authorize a transaction, the API can provide for that in real time. By way of illustration, for any prescriber enrolled, the Actor system may require a DEA number for prescribing or a supervising prescriber's permission. In the first event where a DEA number is not present or where no supervising permissions are granted, the e-prescription API can request this information to allow for NCPDP Script Standard routing or may store the script for subsequent authorization, including targeted notification support and permission update. In this way, Actors or their customer do not have to worry about prior setup or file updates, because their data drives the process. If a provider misses this during setup the API can capture it for first use and enrollment and subsequent script continuity and authorization is maintained.

Following successful test and integration the Actor may then toggle 625 between Base 630 and Revenue Generation Modes 635 via their Registration Account. This also is their gateway to control their profiles, but they do not have to maintain separate customer accounts at this level as this is automated via the e-prescription API.

In Base Operation Mode 630 the data in the Actor system can be maintained by the API. Once they are comfortable, the actor can suspend the need for external reference data sources as the API can aggregate all of these services, or the Actor can maintain these process if desired as they will not impact the API functions.

In Revenue Operation Mode 635 the Actor can observe slight changes in the data represented in UI results such as a filtered list of preferred alternative formulary agents with the option to see more. In this case the UI and using training is not impact but the user experience is greatly enhanced as is the payer drivers.

Actors may need to enable some new workflow features, but the programming impact of these changes is not significant because they use standard and encapsulated API methods, and the amount of changes to achieve a significant lift requires small changes in timely events.

The Actor can use the system to manage their account, profile, contracts, customers, payments, and relationships. Actors can also implement roles-based security policies for other relationship administrators. The Actor may activate, modify, or deactivate features on a site or customer specific level and can activate and deactivate system users at a user level via policies.

### Preferred Formulary Switch

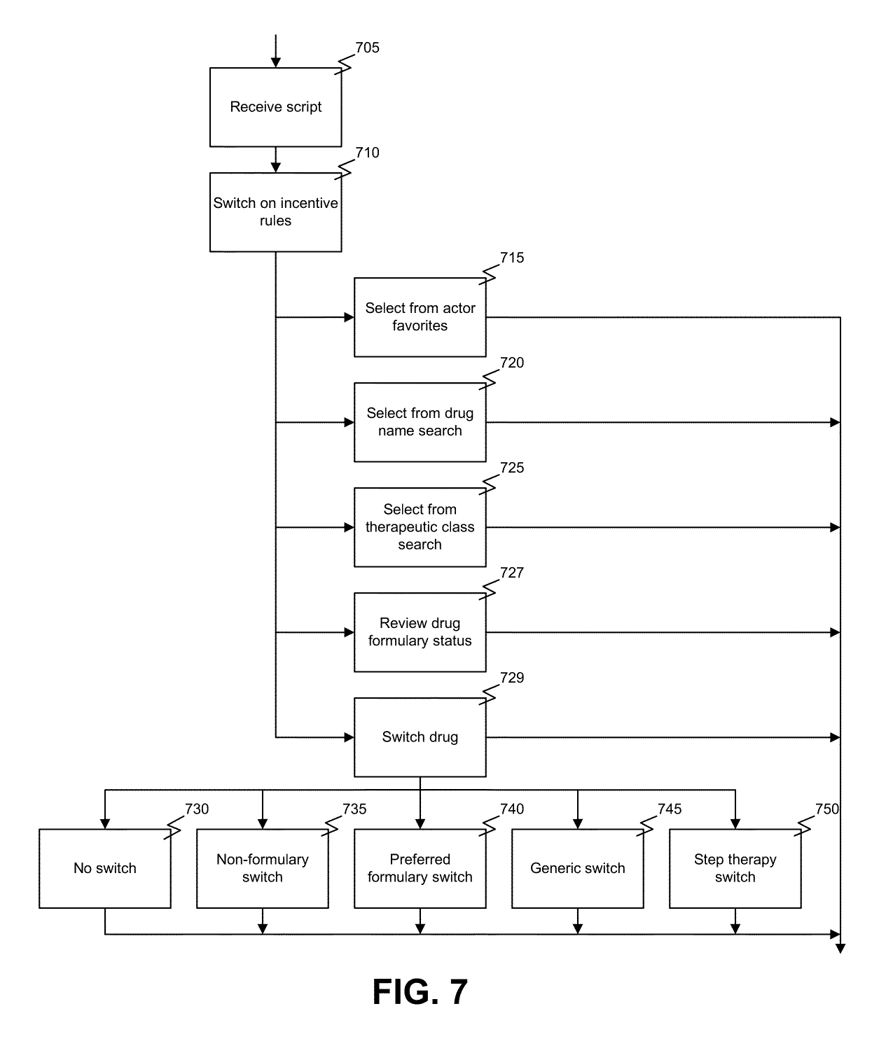

In this set of use cases, the “Actor” can be considered to be a prescriber who has integrated the e-prescription API in revenue generation mode (see above). FIG. 7 is a flowchart illustrating a process for formulary switching according to one embodiment of the present invention. This mode can comprise incentive rules driving preferred and approved Therapeutic Equivalent Formulary Agents. Integration of the e-prescription API will enable more accurate and formulary compliant scripts to be written at the point of care. For example, many Actors do have accurate formulary information when prescribing at the drug or dose level. This solution will enable the Actors to make better informed choices. Additionally, the routing and fulfillment of received 705 electronically and non-electronically written scripts will be more effectively tracked, reported and managed in the system. The following are use cases detailing switched 710 behaviors based on the incentive rules when the e-prescription API is confirmed to be in revenue generation mode.

Use Case: Selection from Actor Favorites 715. In this case, the Actor can access a favorites list of commonly prescribed drugs for an individual Actor or at a group level for a group of Actors.

Use Case: Selection from Drug Name Search 720. In this case, the Actor can search for a drug by name using a search interface and is presented with a list of potential candidates.

Use Case: Selection from Therapeutic Class Search 725. In this case, the Actor can search for a drug by therapeutic class using a hieratical search interface and can be presented with a list of potential candidates.

Use Case: Selection from Review Drug Formulary Status 727. In this case, the Actor can review formulary data and alternatives.

Use Case: Selection from Switch Drug 729. In this case, the Actor can review alternatives and request a change or substitution of a drug. This case can include alternative further use cases including but not limited to making no switch 730, making a non-formulary switch 735, making a preferred formulary switch 740, making a generic switch 745, and making a step therapy switch 750.

Use Case: No Switch 730. Before selecting an agent from the visible list the Actor can visually identify that the desired agent will be covered by the patient pharmacy benefit, how that drug might be dispensed, and that an informational message has been attached. For example, in addition to the visual indicator showing the drug is on formulary, it might also indicated that it is likely to be dispenses as a generic, a preferred brand, or that there may be an incentive opportunity for a preferred agent even though this agent the Actor is selecting is covered. With the exception of informational message, the Actors workflow is unimpeded and the prescribing process continues without interruption.

Use case: Non-Formulary Switch 735. Before selecting an agent from the visible list the Actor can visually identify that the desired agent is off-formulary or will not be covered by the patient's pharmacy benefit plan. Rather than fishing for an equivalent formulary agent, the Actor can select the non-formulary drug and can be presented with a short-list of preferred alternative in ranking order. This includes strength and form formulary selectors in a single, easy to use presentation. This improves Actor productivity because they do not have to go searching through a very broad list of option, and they do not have to remember the names of thousands of equivalent drugs and their dosing combinations. An option to see more can also be indicated if the Actor wants to see the full list which might include 50 to 100 other drugs by brand and generic names, however, experience indicates that the more focused the list the better the selection. The Actor can select one of the Preferred Formulary alternatives and the prescribing process continues.

Use case: Preferred Formulary Switch 740. Before selecting an agent from the visible list the Actor can visually identify that the desired formulary agent is eligible for a preferred formulary incentive. The Actor can select the original formulary agent listed. Within the prescribing process but without interruption the Actor can be alerted to better cost or performance agents for this particular patient that can be selected using a sign click or gesture. If the alternative agent is desired, the Actor can click or gesture to select this agent or continues with the prescribing process. If the alternative agent is selected, the switch can be recorded for analytic purpose and the alternative agent and the prescribing process can continue with the selected agent.

Use case: Generic Switch 745. Before selecting an agent from the visible list the Actor can visually identify the desired drug is eligible to be dispensed in its Generic form. The Actor can select the brand drug and with one click or gesture can automatically select the equivalent generic alternative or continue with the selected drug. Through a configuration parameter Actors can auto-select the preferred behavior or chose to include “Dispense As Generic” or “Dispense As Written” (DAW) on the final prescription. Actors generally do not know or seek to know the chemical or generic names of commonly branded drugs. As a result Actors often search and prescribe commonly branded drugs or drugs consumers request as a result of direct-to-consumer marketing. Unless the prescription is clearly marked “Dispense As Written” or “DAW”, Pharmacist in the US can dispense the Generic form of a Branded agent without the need for engage the original Actor for permission to switch. However, switching to another brand for non-generic therapeutic alternative does require Actor consent.

Use case: Step Therapy Switch 750. Before selecting an agent from the visible list the Actor can visually identify that the desired agent is eligible for a step therapy alternative, particularly when there is no claim data or prescribing history evidence that the alternative has been attempted. Within the prescribing process but without interruption the Actor can be presented with single click or single gesture alternatives. Because claim history is not conclusive in today's market the Actor might inquire if the patient has tried one of the alternatives before selecting or continue with the original prescribing process. Step therapy alternatives are typically less aggressive and less costly alternatives that may also have the benefits or few contraindications and side effects. In some cases, brands may have manufactured a drug that eliminates minor or distasteful side effects that are not common to all people. Payers attempt to control cost by providing the lesser cost equivalent to see if the side effect for this patient materialized before allowing the more expense option.

### Preferred Dispensing Switch and Script Monetization

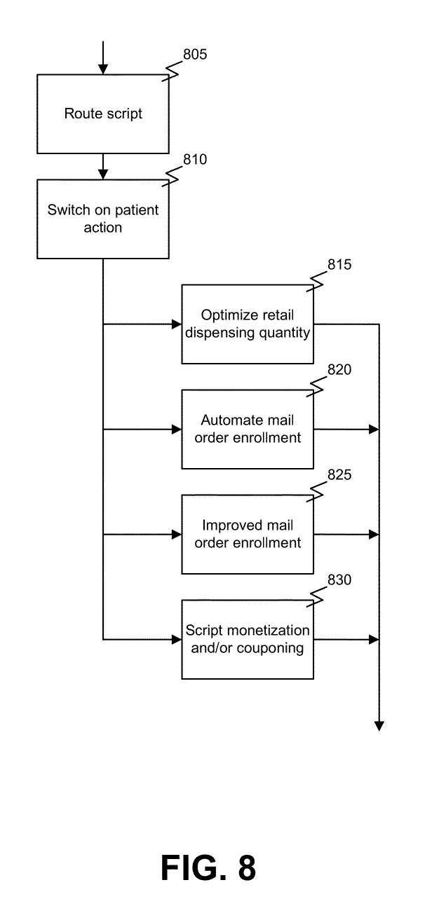

In this set of use cases, the Actor can be considered to be a prescriber. Many payers or their contracted PBMs negotiate discounts for pharmacy networks and reduce overall execution costs when these networks are more readily utilized. Additionally, payers and PBMs often utilized dispensing programs such as 90 day fill programs and mail order to minimize costs or encourage patient adherence. Integrating the e-prescription API in revenue generation mode will provide an updated list of pharmacies and pharmacy contact info for routing. These lists are particularly helpful for physicians on-call or when routing to patient while traveling. Preferred dispensing options can be presented within the prescribing process without interruption to streamline requests for the Actor and provide choice for the patient. The Actor may choose to provide the patient with a printed receipt (or prescription) that when appropriate can be monetized for shared revenue generation on behalf of various stakeholders. Additionally or alternatively, Actors can maintain their abstracted fulfillment position while activating preferred dispensing rules designed to improve efficiency, patient satisfaction, convenience, and adherence and participate in overall wellness objectives articulated by payers and made available through shared incentives. FIG. 8 is a flowchart illustrating a process for dispensing switching and script monetization according to one embodiment of the present invention. As illustrated here, the e-prescription API can also allow Actors to route 805 a prescription and switch 810 on patient action to fill it.

Use case: Optimized Retail Dispensing Quantity 815. When prescribing a prescription which exceeds a supply threshold such as 90 or 120 days, the provider may be presented with a single click or single gesture option to select a more efficient, clinically beneficial or cost effective dispensing choice. If selected, the SIG can be updated to reflect the preferred alternative. If not, the original SIG and supply configuration can be routed.

Use case: Automate Mail Order Enrollment 820. During the prescribing process the option to automatically route a drug to mail order might enable the Actor with a single click or gesture to enroll and route a prescription to mail order, e.g. if the patient is eligible, the selected drug is on formulary, mail order is preferred and a fulfillment house identified for the selected drug, and there is no patient co-pay or responsibility the patient could be automatically enrolled and the prescription routed to mail order.

Use case: Improved Mail Order Enrollment 825. During the prescribing process the option to automatically route a drug to mail order might enable the Actor with a single click or gesture assist the patient in enrolling in mail order for a given prescription. The system would check the status of the patient eligibility, validate that the selected drug is preferred for mail order, identify the mail order fulfillment house, and generate a human readable time-sensitive alpha-numeric identifier for the given patient/mail order/prescription and render the identifier on the prescription, the receipt, and/or message to the patient. The patient then logs onto their Payer Health Portal, enters the identifier, and completes the mail order enrollment process. Once completed, the prescription is automatically routed to the fulfillment house.

Use case: Script Monetization and/or Couponing 830. The Actor can create an electronic prescription with the printed receipt option selected in the e-prescription API. The receipt can be created by de-identifying the patient information and dynamically selecting optional monetized messaging campaigns or coupons. The following are some matching criteria campaigns that can be included in the service: patient interaction or safety warning; patient outreach messaging; resource information disease management programs; discount coupon targeted to upsell opportunities or alternative fill locations; pharmacy consult information; and/or care management program awareness. These options can exist for a printed prescription as well. Prescriptions or receipts can include the identifier used to pull the prescription for single fill and fraud reduction purposes.

### Payer Processing Use Cases

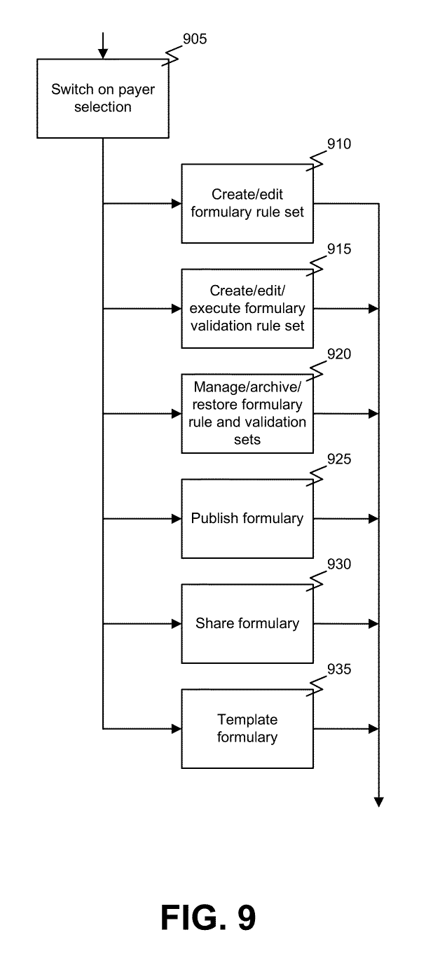

In this set of use cases, the Actor can be considered to be a payer, e.g., an insurance company, etc. In these cases, the Actor can manage the drugs on formulary. Their goal is to maximize care and options while minimizing costs. To do this, they offer a large selection of drugs in tiers from most preferred to not covered. Each successive tier raises the cost to both the payer and the member. FIG. 9 is a flowchart illustrating a process for payer processing according to one embodiment of the present invention. As illustrated here, the Actor can switch 905 between the following use cases based on an API selection:

Use case: Create/Edit Formulary Rule Set 910. The Actor must decide from all the drugs available across all delivery methods and dosages which formulary tier they belong in. There are set periods during the year the Actor may update their formularies under which they will pay out for the remaining duration. The Actor can log onto the system and select a new formulary rule set. A formulary rule set is a set of rules which determine if a drug/dosage/delivery combination is valid (and thus included) in the final published formulary. Rules may be broad, as in include all generics and/or very specific down to the exact National Drug Code (NDC). Rules may be reordered and are processed in an order of precedence. All the drugs affected by the rule are available to the Actor. Individual rules and sets of rules may be named, saved, and reused across different formularies. Using formulary rule sets virtually eliminates typographical errors and dramatically reduces all the other errors caused by manual entry. Rule sets can be individually validated, thus making finding and managing formulary logic errors much easier.

Use case: Create/Edit/Execute Formulary Validation Rule Set 915. The Actor needs to validate the internal consistency of their formularies as well as be in compliance with company, state, and federal mandated formulary requirements. The Actor can select from a list of current rules (both state and federal) which they which to apply to their final formulary (or formulary rule sets) to see if their formulary is in compliance. The Actor can also create their own validation rules and utilize them. Since the actual formulary is not generated until the Actor publishes it, the rules stay current. This process significantly reduces time, cost, and increases the accuracy of the final product.

Use case: Manage/Archive/Restore Formulary Rule and Validation Sets 920. The Actor needs to manage their rules and validation sets. Also, rules and validation can be published by other parties and shared for use by all Actors. The Actor can utilize the formulary management component of the system to see the rule and validation sets that are available and/or that they have created, edited, named and stored. They can archive, edit, restore, and otherwise manage each set individually or together. Making any changes to any set will alert the Actor of published formularies effected by the change.

Use case: Publish Formulary 925. After building/selecting the rules and validation sets for a given formulary, the Actor can decide that the formulary is now correct and can publish it. A published formulary is fully resolved, having applied the appropriate rules and validation sets. The system can save the resolved formulary as well as a copy of the rules and validation sets used. This published formulary can be named and time stamped and placed into the list of published formularies. A published formulary cannot be edited and has read-only access. A published formulary can also be shareable. A simple action can be used to publish any number of formularies. Recalling any published formulary is facilitated since all published formularies are centrally stored. Published formulary can also be revoked (removed from published list and read/write access granted), archived (removed from published list but still available via archived list), and restored from archive.

Use case: Share Formulary 930. Once published, an Actor will want to share the new formulary with any number of stakeholders. The Actor can maintain a list of stakeholders, each with their format and target information stored in the system. The Actor can select what stakeholder to publish to and the system does any required transformation of the formulary to match the stakeholder's requirements and send the file via whatever secure system the stakeholder selected.

Use case: Template Formulary 935. Once published, an Actor will want to select some formularies and create a template formulary. A template can be edited like a newly created (unpublished) formulary. Template formularies can also be shared with any number of stakeholders.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for managing health care information and delivery of health care services, the method comprising:
maintaining a set of workflows, each workflow defining one or more processes for managing a set of health care information or the delivery of one or more health care services according to a plurality of modes of operation;
maintaining a set of reference data and a set of rules applicable to the set of health care information or the delivery of the one or more health care service;
receiving health care transaction information from one or more parties, the one or more parties comprising one or more of a patient, a health care provider, a pharmacy, or a payer; and
executing one or more of the workflows to process the received health care transaction information based on the set of reference data and the set of rules.

2. The method of claim 1, wherein the plurality of modes of operation include a base operation mode.

3. The method of claim 2, wherein the received health care transaction information comprises a prescription and wherein processing the received health care transaction information comprises routing of the received health care transaction information between parties.

4. The method of claim 3, wherein the reference data comprises one or more of drug reference data, payer formulary data, drug history data, or benefit eligibility data and wherein processing the received health care transaction information comprises aggregating the drug reference data and payer formulary data from a plurality of different sources.

5. The method of claim 1, wherein the plurality of modes of operation include a revenue generation mode.

6. The method of claim 5, wherein the received health care transaction information comprises a prescription and wherein processing the received health care transaction information comprises performing one or more payer incentive or revenue sharing functions.

7. The method of claim 6, wherein the functions include enrollment functions.

8. The method of claim 6, wherein the functions include tracking, reporting, and managing the routing and fulfillment of the prescription.

9. The method of claim 6, wherein the functions include switching one or more payer formularies.

10. The method of claim 6, wherein the functions include switching a brand drug for a generic drug.

11. The method of claim 6, wherein the functions include switching therapies.

12. The method of claim 6, wherein the functions include one or more preferred dispensing functions.

13. The method of claim 6, wherein the functions include optimizing a dispensing quantity.

14. The method of claim 6, wherein the functions include automating a mail order enrollment.

15. The method of claim 6, wherein the functions include one or more script monetization or couponing functions.
